(19) United States
(12) Patent Application Publication
(10) Pub. No.: US 2011/0221589 A1
(43) Pub. Date: Sep. 15, 2011

(54) HAZARD LIGHT FOR A VEHICLE

(75) Inventors: Howard Stephen LeBeau, Webberville, MI (US); William Frederick Foster, Grand Ledge, MI (US); Ronald Eugene Hannold, Charlotte, MI (US)

(73) Assignee: Spartan Motors

(21) Appl. No.: 12/721,746

(22) Filed: Mar. 11, 2010

(51) Int. Cl. B60Q 1/26

(52) U.S. Cl. 340/468; 362/501

(57) ABSTRACT

One embodiment of the invention relates to a light system for use in a vehicle. The light system includes a door coupled to the vehicle, a portion of the door having a surface that is visible from outside of the vehicle when the door is opened, and an illumination device disposed on the door and comprising a plurality of illuminated elements. The illumination device is visible from outside of the vehicle when the door is opened. The illuminated elements are capable of being illuminated in a pattered sequence after the door is opened.

### BACKGROUND

Emergency environments can be very dangerous, for both those involved and for emergency personnel there to help. When an emergency vehicle is in use in such an environment, it may be parked in an unpredictable position relative to public roads and the right of ways of both vehicles and pedestrians.

Vehicles, especially, can pose a danger to emergency personnel. An open door of an emergency vehicle stopped on the side of the road (e.g, to respond to a traffic collision) may protrude into an adjacent traffic lane. An inattentive driver may fail to see the open door and strike it with their vehicle, potentially causing damage to both vehicles and harm to emergency personnel in the area.

Likewise, emergency vehicles may respond to an accident scene in a pedestrian area. Pedestrian traffic may need to be routed around the accident scene to limit the exposure of the public to a potentially dangerous situation.

The highest point of a standard emergency vehicle is at the roof line. While the emergency vehicles may have a light bar on the roof, the light bar may be obscured from the rear by equipment, such as on a ladder truck. Further, light bars do nothing to indicate the presence of an open door that may protrude into a vehicular or pedestrian right of way.

It would be advantageous to provide a visual indication that the door of an emergency vehicle is opened and an intuitive signal to approaching pedestrians or motorists to move around the vehicle.

### SUMMARY

One embodiment of the invention relates to a light system for use in a vehicle. The light system includes a door coupled to the vehicle, a portion of the door having a surface that is visible from outside of the vehicle when the door is opened, and an illumination device disposed on the door and comprising a plurality of illuminated elements. The illumination device is visible from outside of the vehicle when the door is opened. The illuminated elements are capable of being illuminated in a pattered sequence after the door is opened.

Another embodiment relates to an emergency vehicle. The emergency vehicle includes a vehicle body, a door coupled to the vehicle body with one or more hinges, and a light system. The door has a surface that is visible to a person outside of the vehicle when the door is opened. The light system includes an illumination device with a plurality of illuminated elements disposed on the surface of the door and a control system. The control system causes the illuminated elements to be illuminated in a sequence when the door is opened.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a perspective view of a vehicle with an open door, including a hazard lighting system according to an exemplary embodiment.

FIG. 2 is a schematic top view of an accident or emergency scene, showing an emergency vehicle with an open door and illuminated hazard lights.

FIGS. 3A and 3B are a side view and a top view, respectively, of a hazard light for a vehicle according to an exemplary embodiment.

FIG. 4 is a perspective view of a vehicle interior, showing the light system when the vehicle door is closed.

### DETAILED DESCRIPTION OF THE PREFERRED EMBODIMENTS

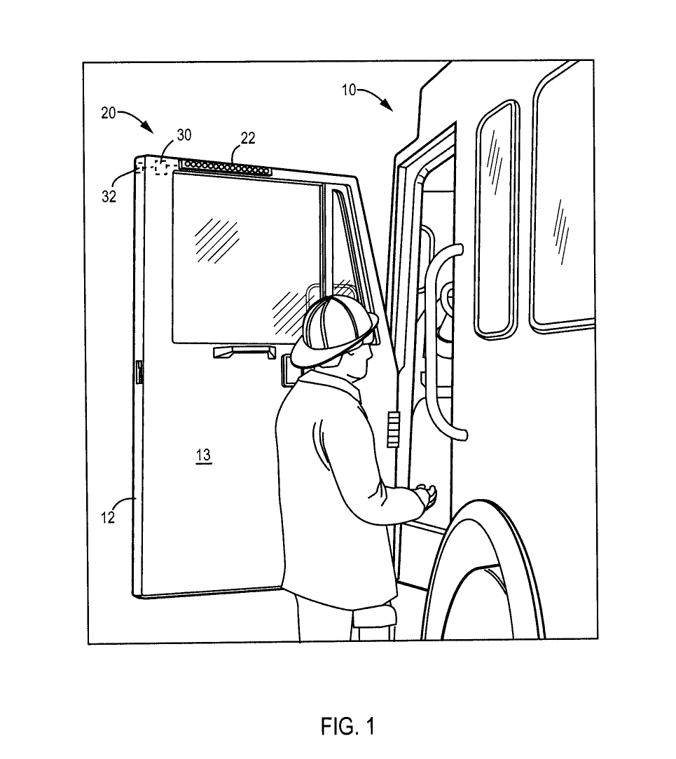

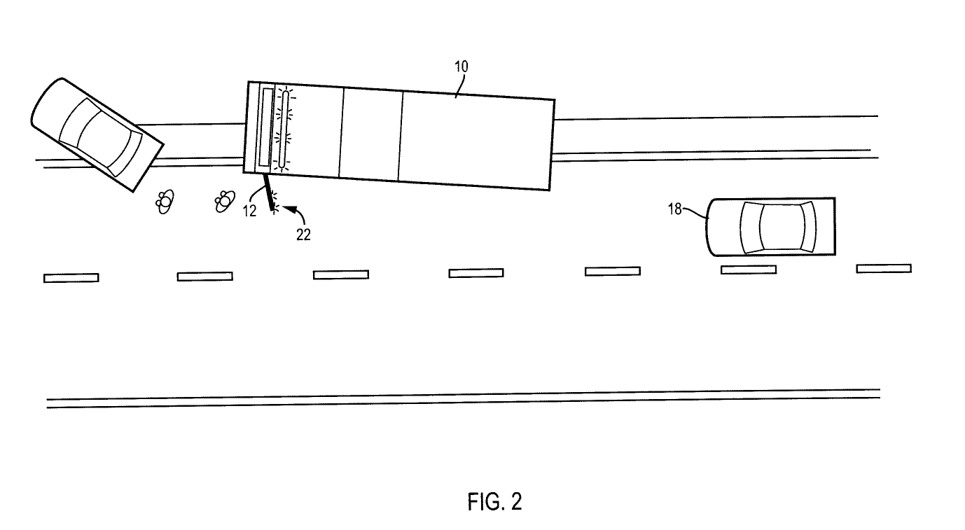

Referring to FIG. 1, a vehicle 10 is shown according to an exemplary embodiment. The vehicle 10 may be, for example, a police squad car, an ambulance, a fire engine, a tow truck or any other emergency or utility vehicle that may routinely stop on the side of a road to respond to an emergency situation. Emergency personnel may have to open a door 12 of the vehicle 10 into traffic and exit into the path of passing vehicles (e.g., vehicle 18 in FIG. 2). An inattentive driver of a passing vehicle may fail to see that the door 12 of the emergency vehicle 10 is open, striking the door 12, damaging the emergency vehicle 10, the passing vehicle 18 and potentially injuring emergency personnel or pedestrians in the area. By providing an intuitive signal that indicates the door 12 of a stopped vehicle 10 is opened, collisions between passing vehicles 18 and emergency vehicles 10 can be reduced, reducing both repair costs and injuries or deaths to emergency personnel or other people in the area of a stopped emergency vehicle 10.

To increase the visibility of the opened door 12, a light system 20 may be provided to provide an intuitive visual queue to passing motorists or pedestrians that the door 12 is opened and that an effort should be made to move around the vehicle 10. Light system 20 includes an illumination device 22 (e.g., warning light, emergency light, hazard light, Foster light, etc.) coupled to the door 12 and a control system 30 that causes the illumination device 22 to light up when the door 12 is opened.

The illumination device 22 is disposed on the door 12 such that it visible to a viewer outside of the vehicle when the door 12 is opened. Emergency vehicles 10 are most likely stopped while facing the same direction as traffic and doors 12 are generally hinged such that the interior surface 13 of the door 12 faces the rear of the vehicle when opened. Therefore, according to a preferred embodiment, the illumination device 22 is coupled to the interior surface 13 of the door 12 such that it is visible to motorists or pedestrians approaching the rear of the vehicle 10. However, in other embodiments, an illumination device 22 may be coupled to the exterior surface of the door 12 in place of or in addition to the illumination device 22 coupled to the interior surface 13 of the door 12. An illumination device 22 on the exterior surface of the door may be provided to provide a visual indication of an open door 12 if the emergency vehicle 10 is stopped facing oncoming traffic or if the door opens on rearward hinges so that the exterior surface of the door 12 faces the rear of the vehicle 10 when the door 12 is opened.

To increase visibility, the illumination device 22 is disposed on the upper portion of the door 12 so that it is less likely to be obscured by emergency personnel or other pedestrians walking between the door 12 and an approaching motorist or pedestrian. According to an exemplary embodiment the illumination device 22 is provided above a window opening in the door 12, proximate to the outer edge of the door 12. The placement of the illumination device, as shown in FIG. 1, visually extends the perceived width of the vehicle 10.

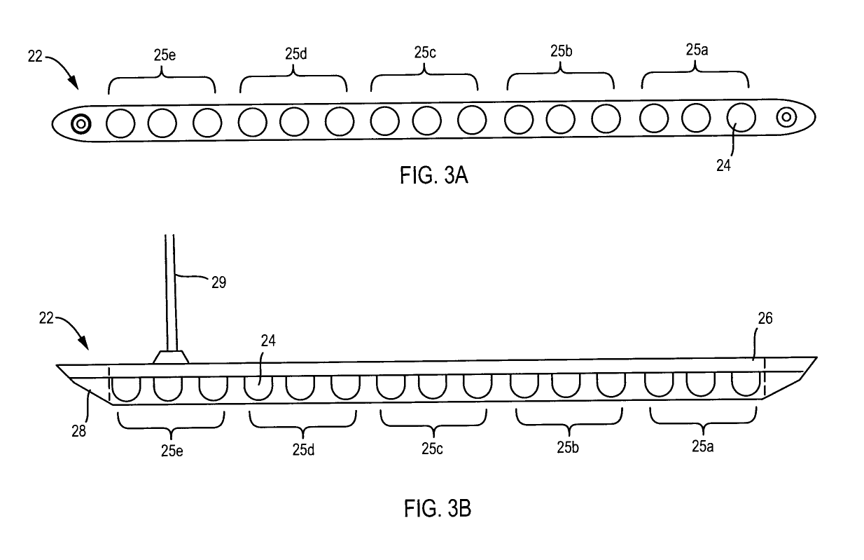

Referring to FIGS. 3A and 3B, the illumination device 22 may be a horizontally elongated body. According to an exemplary embodiment, the illumination device 22 comprises multiple, individually controlled illuminated elements 24, such as light emitting diodes (LEDs). LEDs are desirable because they have a long life, a relatively low energy consumption compared to other options, are capable of high switching rates, and are reliable. The multiple illuminated elements 24 can be illuminated in a sequence to increase the visibility of the illumination device 22 and provide intuitive directions to a motorist or pedestrian of what action they should take to avoid the stopped emergency vehicle 10. The illuminated elements 24 are coupled to a base or body 26 and covered with a transparent dome 28. According to an exemplary embodiment, the illumination device 22 includes illuminated elements 24 that are sequentially illuminated in groups 25. According to a preferred embodiment, the illumination device 22 includes five groups 25a-25e of illuminated elements 24, each group 25 comprising three illuminated elements 24. In other embodiments, the illuminated elements 24 may be grouped in smaller or larger groups. In still other embodiments, the illuminated elements 24 may not be illuminated in groups and may instead be illuminated individually.

In other embodiments, the illumination device 22 can be any device that emits sufficient illumination to be visible to a nearby motorist or pedestrian approaching the vehicle 10. For instance, the illuminated elements may be incandescent bulbs, organic LEDs, high power LEDs, light emitting polymers (LEPs), etc.

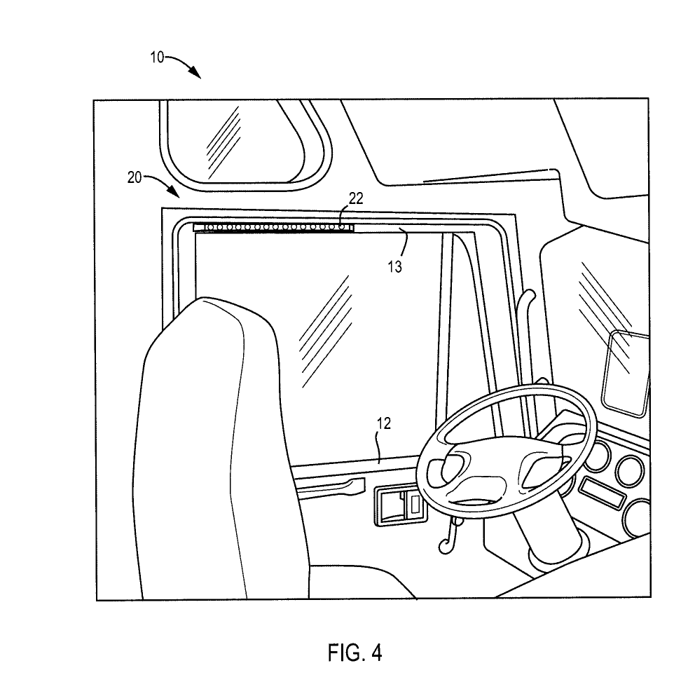

As shown in FIGS. 1 and 4, the small vertical height of the illumination device 22 allows it to be placed on a vehicle door 12 with only a small distance between the top of the window opening and the top of the door.

The base 26 may include features to couple the illumination to the door 12 (e.g., holes for threaded fasteners, a flange that is welded to a metallic member, snap features, an adhesive, etc.). The illumination device 22 may be configured to be permanently attached to the door and placed during construction of the door or may configured to be provided as a separate unit that can be coupled to an existing door.

The illuminated elements 24 are illuminated in a sequence by the control system 30. The control system 30 communicates with the illumination device 22 through electrical leads 29 that extend from the body 26 to the control system 30. According to one exemplary embodiment, the control system 30 is integrated into the base 26 of the illumination device 22. According to other exemplary embodiments, the control system 30 may be located remote from the illumination device 22. The control system 30 may provide other functionality such as communicating with the vehicle's other lights (e.g., to coordinate the behavior of the illumination device 22 with the behavior of a light bar) or controlling the power flow to the illumination device 22 (e.g., stepping down or stepping up voltage, switching power flow on and off, etc.).

Referring again to FIGS. 3A-3B, the illumination device 22 is coupled to the door 12 such that the first group 25a of illuminated elements 24 is closest to the vehicle 10. The control system 30 is configured to first illuminate the first group 25a. After a period of time, the second group 25b is illuminated. Likewise, groups 25c-25e are also illuminated in sequence, creating a pattern that intuitively draws the eye of the viewer from the body of the vehicle 10 to the outside edge of the door 12.

According to an exemplary embodiment, the first group 25a is illuminated for a period of time such that it is still illuminated when the final group 25e is illuminated. According to other exemplary embodiments, the period of time each group 25 is illuminated may vary relative to the amount of time between the illumination of the next group 25 in the sequence. For example, if the group 25 is illuminated for a brief period of time, it may be turned off before the next group 25 is illuminated. The control system 30 may vary the relative times between the duration each group is illuminated and the time between the activation of neighboring groups. In this way, the perceived length of the illuminated portion of the illuminating device 22 and the speed with which the pattern moves across the door 12 may be varied.

As shown in FIG. 4, according to one exemplary embodiment, the illumination device 22 is viewable to a passenger of the vehicle 10 when the door 12 is closed. The illumination device 22 is triggered by the switch or other sensor 32 coupled to the vehicle body or to the door 12. The sensor 32 is configured to activate the illumination device 22 with a minimal opening of the door 12. Having the illumination device 22 visible to a passenger inside the vehicle 10 provides several advantages. Some emergency vehicles lock out certain functions, such as putting the vehicle in drive, if there an open door is sensed. Because the illumination device 22 is configured to be activated automatically when the door 12 is opened, the illumination device 22 provides an easy to recognize indication which door is opened, even if it is only slightly ajar. Further, the sequential illumination of the illumination device 22 provides a visual cue to a passenger that they are opening the door 12. When the door 12 is partially opened, the sequentially illuminated elements 24 intuitively directs a viewer's eyes, not to the side of the vehicle 10, such as when the door 12 is fully opened, but to the rear of the vehicle 10. Because the passenger of the emergency vehicle 10 may be potentially entering a dangerous area, such as a traffic lane, directing the eyes of the passenger rearward can help make them more aware of dangers that may be approaching from the rear of the vehicle 10 (e.g., a passing vehicle 18).

The illumination device 22 is configured to be activated automatically when the door 12 is opened, but may have other functionality as well. For example, the illumination device 22 may be configured to provide steady lighting to passenger inside the vehicle 10 when the door 12 is closed, similar to an overhead dome light or map light. Further, the vehicle 10 may include a manual override switch to allow a user to turn the illumination device 22 on or off or to change the state of the illumination (e.g., sequential, flashing, blinking, steady, etc.).

While the illumination device 22 is illustrated as being a horizontally elongated body that extends approximately half the width of the door 12, many variations are possible. For example, the illumination device may comprise several portions, each with one or more illuminated elements, that are arranged along the top portion of the door. In other embodiments, the illumination device may further comprise a vertically elongated portion that is provided along the outer edge of the vehicle door, opposite of the hinges. This vertical portion may be continuous with the horizontal portion, forming an L-shaped body or may be s separate unit.

In still other embodiments, the illumination device may be otherwise shaped. For example, the illumination device may be shaped as an arrow or another shape to further enhance the visual clarity of the illumination device. In other embodiments, the illumination device may include printed, painted or otherwise applied indicia, such as arrows or words.

The individual illuminated elements 24 may be illuminated in a pattern other than a sequential pattern from the inside of the vehicle to the outside. For example, the illuminated elements may be generally vertically arranged and be illuminated sequentially from top to bottom or vice versa. The illuminated device 22 may comprise a series of concentric circles that are illuminated sequentially.

In other embodiments, the elements 24 may be illuminated in another pattern, such as in a blinking pattern, a flashing pattern, or randomly.

The illuminated elements 24 may be a wide variety colors, including amber, red, blue, green, white, etc. The choice of colors for the particular vehicle may be determined by the type of vehicle and the laws of the area where the vehicle will be utilized. The illuminated elements 24 of the device 22 may all be one color or may be multiple colors. The illuminated elements 24 may be the same color as other emergency and warning lights on the vehicle (such as a light bar) or may be independently colored.

While the vehicle 10 is generally described above as an emergency vehicle, the light system 20 may be used for other vehicles as well. For example, utility vehicles such as crane trucks, garbage trucks, cherry pickers, etc. are often required to stop on the side of the road, with the driver or passengers opening a door 12 into traffic. The light system 20 may be deposed on one or more doors of a utility vehicle to provide a visual alert that the door 12 is open and utility personnel may be in the area.

The construction and arrangements of the light system, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

What is claimed is:

1. A light system for use on a vehicle, comprising:
a door coupled to the vehicle, a portion of the door having a surface that is visible from outside of the vehicle when the door is opened, and
an illumination device disposed on the door and comprising a plurality of illuminated elements, and being visible from outside of the vehicle when the door is opened, and
wherein the illuminated elements are capable of being illuminated in a pattered sequence after the door is opened.

2. The light system of claim 1, wherein the illumination device is disposed above a window opening in the door.

3. The light system of claim 2, wherein the illuminated elements are arranged horizontally.

4. The light system of claim 3, wherein the illuminated elements are configured to be illuminated in sequence along the length of the illumination device after the door is opened.

5. The light system of claim 4, wherein the illuminated elements are illuminated in sequentially starting with the illuminated elements that are closest to the portion of the door nearest the vehicle after the door is opened and ending with the illuminated elements that are distal from the illuminated elements that are initially illuminated.

6. The light system of claim 5 wherein the sequence is a repeating sequence.

7. The light system of claim 1, wherein the illuminated elements comprise light emitting diodes, incandescent bulbs, or organic light emitting diodes.

8. The light system of claim 1, wherein the illumination device includes a vertical portion proximate to the edge of the door surface that is furthest away from the vehicle after the door has been opened.

9. The light system of claim 1, wherein the illumination device does not shut off until the door is completely closed.

10. An emergency vehicle, comprising:
a vehicle body
a door coupled to the vehicle body with one or more hinges, the door having a surface that is visible to a person outside of the vehicle when the door is opened,
a light system, comprising
an illumination device disposed on the surface of the door and comprising a plurality of illuminated elements, and
a control system,
wherein the control system causes the illuminated elements to be illuminated in a sequence when the door is opened.

11. The emergency vehicle of claim 10, wherein the vehicle is a fire engine, an ambulance, a squad car, or a tow truck.
